(19) United States
(12) Patent Application Publication
(10) Pub. No.: US 2016/0366500 A1
(43) Pub. Date: Dec. 15, 2016

(54) Sound Generator

(71) Applicant: Chengliang Wang, Shenzhen (CN)

(72) Inventor: Chengliang Wang, Shenzhen (CN)

(73) Assignee: AAC Technologies Pte. Ltd., Singapore city (SG)

(21) Appl. No.: 15/004,981

(22) Filed: Jan. 24, 2016

(30) Foreign Application Priority Data
Jun. 10, 2015 (CN) 201520399138.3

(51) Int. Cl. H04R 1/02

(52) U.S. Cl. CPC H04R 1/025

(57) ABSTRACT

An sound generator is disclosed. The sound generator, includes: a housing having a sound opening for radiating acoustic waves; at least one brace spanning across the sound opening, the brace having two ends both fixed on the housing around the sound opening; and a dust screen completely covering the sound opening, the dust screen including a first part located outside the sound opening and a second part covering the sound opening. The first part is fixed by adhesive on the housing and being around the sound opening, and the second part is fixed by adhesive on the brace.

### FIELD OF THE INVENTION

The present disclosure relates to sound generators, more particularly to a sound generator used in portable electronic devices.

### DESCRIPTION OF RELATED ART

The sound generator of existing technology includes a housing and a dust screen. The housing is provided with an opening for the sound generator to emit acoustic waves to outside. The dust screen is fixed by adhesive on the housing around the opening and covers entire sound opening. However, when the aperture area of the sound opening is bigger, the larger part of the dust screen will be suspended in the sound opening and the dust screen will vibrate when the sound generator works so the sound generator produces audible noise.

Therefore, it is necessary to provide a new sound generator to overcome the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exploded view of a sound generator in accordance with a first embodiment of the present disclosure.

FIG. 2 is an exploded view of a sound generator in accordance with a second embodiment of the present disclosure.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

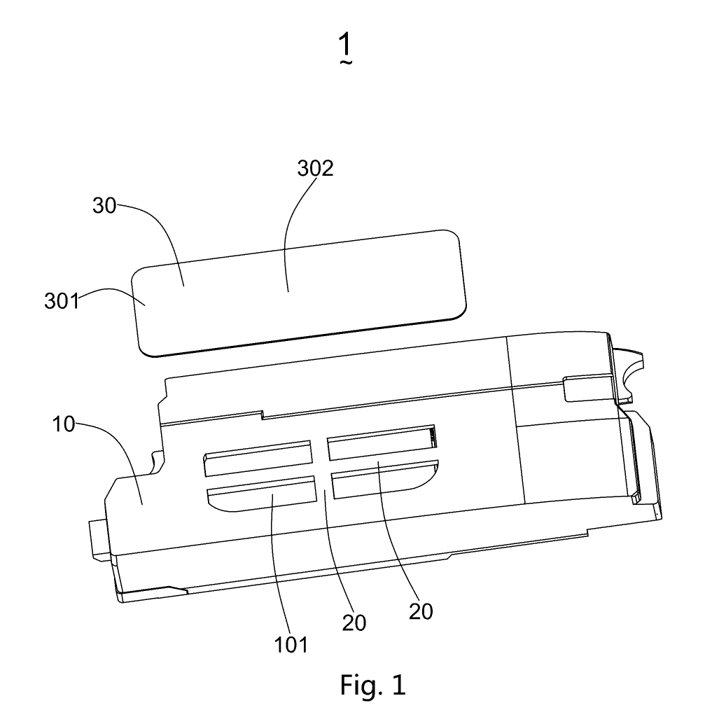

As shown in FIG. 1, the present disclosure discloses a sound generator 1 in accordance with a first embodiment. The sound generator 1 includes a housing 10. The housing 10 has a sound opening 101 for the sound generator 1 to emit acoustic waves to outside. The sound generator 1 includes further at least one brace 20 which are spanned across the sound opening 101. Both ends of the braces 20 are fixed on the housing 10 around the sound opening 101. The sound generator includes further a dust screen 30 which covers completely the sound opening 101. The dust screen 30 is divided into two parts: the first part 301 is located outside the sound opening 101 and the second part 302 covers the sound opening 101. The first part 301 is fixed by adhesive on the housing 10 around the sound opening 101. The second part 302 is fixed by adhesive on the braces 20. At least one brace 20 passes across the center of the sound opening 101. The braces 20 of the sound generator 1 in the embodiment are arranged crossly. Preferably, the intersection of the braces 20 is coincidental with the center of the sound opening 101. The braces 20 and the housing 10 are molded together for convenience in production.

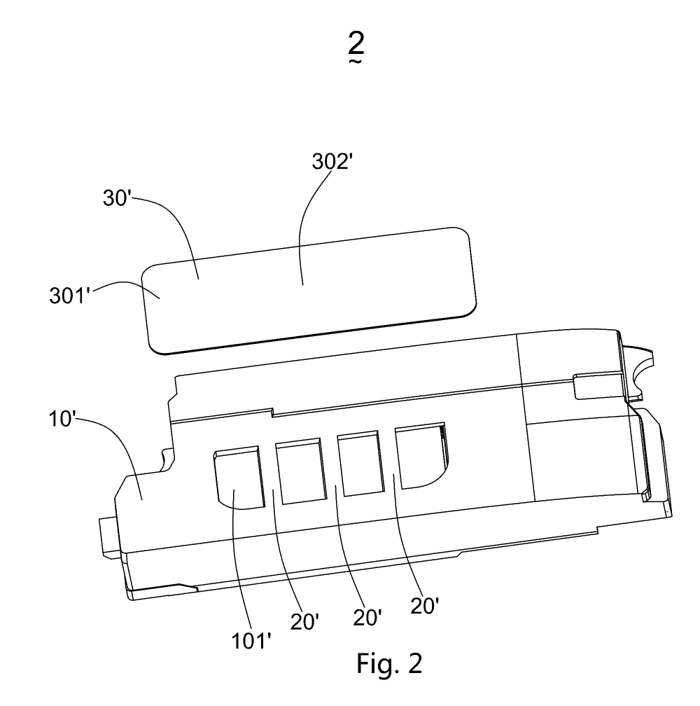

As shown in FIG. 2, a sound generator 2 in accordance with a second embodiment, includes a housing 10′. The housing 10′ has sound opening 101′ for the sound generator 2 to emit acoustic waves to outside. The sound generator 2 includes further at least one brace 20′ which is spanned across the sound opening 101′. Both ends of the braces 20′ are fixed on the housing 10′ around the sound opening 101′. The sound generator 2 includes further a dust screen 30′ which covers completely the sound opening 101′. The dust screen 30′ is divided into two parts: a first part 301′ is located outside the sound opening 101′ and a second part 302′ covers the sound opening 101′. The first part 301′ is fixed by adhesive on the housing 10′ around the sound opening 101′. The second part 302′ is fixed by adhesive on the braces 20′. At least one brace 20′ passes across the center of the sound opening 101′. The braces 20′ of the sound generator 2 in the embodiment are arranged in parallel. The braces 20′ and the housing 10′ are molded together for convenience in production.

The dust screen which is suspended in larger part before in the opening can be fixed now by the braces with adhesive. The technical problem, that the dust screen will vibrate when the sound generator works so the sound generator produces audible noise, can be solved then. The sound generator disclosed by the utility model can avoid audible noise.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sound generator, comprising:
a housing having a sound opening for radiating acoustic waves;
at least one brace spanning across the sound opening, the brace having two ends both fixed on the housing around the sound opening;
a dust screen completely covering the sound opening, the dust screen including a first part located outside the sound opening and a second part covering the sound opening; wherein
the first part is fixed by adhesive on the housing and being around the sound opening, and the second part is fixed by adhesive on the brace.

2. The sound generator as described in claim 1, wherein the braces are arranged in parallel.

3. The sound generator as described in claim 1, wherein the braces are arranged in cross.

4. The sound generator as described in claim 1, wherein the brace passes through the center of the sound opening.

5. The sound generator as described in claim 3, wherein the intersection of the braces is coincidental with the center of the sound opening.

6. The sound generator as described in claim 1, wherein the brace and the housing are molded together.
